(19) United States
(12) Patent Application Publication
(10) Pub. No.: US 2021/0013464 A1
(43) Pub. Date: Jan. 14, 2021

(54) BATTERY REPLACEMENT

(71) Applicant: HEWLETT-PACKARD DEVELOPMENT COMPANY, L.P., Spring, TX (US)

(72) Inventors: ALEXANDER WAYNE CLARK, SPRING, TX (US); ANDREW ELSEY, SPRING, TX (US); CHAN-WOO PARK, SPRING, TX (US)

(21) Appl. No.: 16/962,664

(22) PCT Filed: Mar. 15, 2018
(86) PCT No.: PCT/US2018/022627

§ 371 Date: Jul. 16, 2020

(51) Int. Cl. H01M 2/10; H04M 1/02

(52) U.S. Cl. CPC H01M 2/1066; H01M 10/052; H04M 1/0262

(57) ABSTRACT

An example battery replacement device includes a body, and an alignment guide coupled to the body to fit around a portion of an electrical device to guide the battery replacement device in alignment with the electrical device. The battery replacement device also includes a battery coupling device formed at a first portion of the body to couple to a used battery of the electrical device, and a recess defined in a second portion of the body to retain a replacement battery.

### BACKGROUND

Electric batteries are devices that include electrochemical cells with external connections provided to power electrical devices such as computing devices, laptop computing devices, smartphones, tablets, and a myriad of other types of devices. The battery, when connected to an external circuit, will flow and deliver energy to the electrical device, and electrolytes are able to move as ions within, allowing the chemical reactions to be completed at the separate terminals and so deliver energy to the circuits of the electrical device. It is the movement of those ions within the battery which allows current to flow out of the battery to perform work.

### BRIEF DESCRIPTION OF THE DRAWINGS

The accompanying drawings illustrate various examples of the principles described herein and are part of the specification. The illustrated examples are given merely for illustration, and do not limit the scope of the claims.

FIG. 1 is a block diagram of a battery replacement device, according to an example.

FIG. 2 is a block diagram of a battery replacement system, according to an example.

FIG. 3 is a block diagram of a battery replacement device, according to another example.

FIG. 4 is an isometric view of a battery replacement device, according to an example.

FIG. 5 is an isometric view of a battery replacement device, according to an example.

FIG. 6 is a top plan view of a battery replacement device, according to an example.

FIG. 7 is a bottom plan view of a battery replacement device, according to an example.

FIG. 8 is an isometric view of the battery replacement device being used in connection with an electrical device to remove a used battery of the electrical device before removal of the used battery, according to an example.

FIG. 9 is a plan view of the battery replacement device being used in connection with an electrical device to remove a used battery of the electrical device before removal of the used battery, according to an example.

FIG. 10 is an isometric view of the battery replacement device being used in connection with an electrical device to remove a used battery of the electrical device after removal of the used battery, according to an example.

FIG. 11 is an isometric view of the battery replacement device being used in connection with an electrical device to replace a used battery of the electrical device with a replacement battery and depicts the battery replacement device before seating of the replacement battery, according to an example.

FIG. 12 is a plan view of the battery replacement device being used in connection with an electrical device to replace a used battery of the electrical device with a replacement battery and depicts seating of the replacement battery, according to an example.

FIG. 13 is an isometric view of the battery replacement device being used in connection with an electrical device to replace a used battery of the electrical device with a replacement battery and depicts seating of the replacement battery and removal of the battery replacement device from the electrical device, according to an example.

FIG. 14 is a flowchart showing a method of replacing a battery in an electrical device, according to an example.

FIG. 15 is an isometric view of the batteryreplacement device including a lid, according to an example.

Throughout the drawings, identical reference numbers designate similar, but not necessarily identical, elements. The figures are not necessarily to scale, and the size of some parts may be exaggerated to more clearly illustrate the example shown. Moreover, the drawings provide examples and/or implementations consistent with the description: however, the description is not limited to the examples and/or implementations provided in the drawings.

### DETAILED DESCRIPTION

Batteries convert chemical energy directly to electrical energy. Some batteries may be classified as lithium polymer batteries, or, more correctly, lithium-ion polymer batteries (hereinafter Li-poly batteries). Li-poly batteries are rechargeable batteries that utilize lithium-ion technology using a polymer electrolyte instead of a liquid electrolyte. In one example, high conductivity semisolid (gel) polymers form this electrolyte. Li-poly batteries provide a higher specific energy than other lithium battery types and are being used in applications where weight is a desired feature such as in laptop or tablet computers, smart phones, or even radio-controlled aircraft.

These Li-poly batteries may use a solid polymer electrolyte (SPE) such as poly(ethylene oxide) (PEO), poly(acrylonitrile) (PAN), poly(methyl methacrylate) (PMMA) or poly(vinylidene fluoride) (PVdF). Further, these Li-poly batteries may include four main components: a positive electrode, a negative electrode, a separator, and an electrolyte. The separator itself may be a polymer, such as a microporous film of polyethylene (PE) or polypropylene (PP). The positive electrode may include a lithium-transition-metal-oxide (such as LiCoO₂ or LiMn₂O₄), a conductive additive, and a polymer binder of poly(vinylidene fluoride) (PVdF). The negative electrode material may include the same three parts, only with carbon replacing the lithium-metal-oxide.

Unlike other types of lithium-ion cells, which have a rigid metal case, Li-poly batteries include a flexible, foil-type (polymer laminate) case, so they are relatively unconstrained. Thus, Li-poly batteries may be referred to as a “soft-pack” batteries given its non-rigid form factor. By themselves the cells are over 20% lighter than equivalent cylindrical cells of the same capacity. Being lightweight is an advantage when the intended application benefits from a minimum weight, such as in the case of laptop or tablet computers, smart phones, or even radio-controlled aircraft.

However, it has demonstrated that Li-poly battery cells are affected by the same problems as other lithium-ion cells including overcharge, over-discharge, over-temperature, short circuit, crush and nail penetration that may all result in a catastrophic failure, including the pouch rupturing, the electrolyte leaking, and fire. All Li-poly cells expand at high levels of state of charge (SOC) or over-charge, due to a slight vaporization of the electrolyte. This may result in delamination, and thus bad contact of the internal layers of the cell, which, in turn, may bring diminished reliability and overall cycle life of the cell. This is very noticeable for Li-poly batteries, which may visibly inflate due to lack of a hard case to contain their expansion. Thus, it is not advisable to allow a user or owner of an electrical device into which a Li-poly battery is used, to replace or even touch the used battery or a new, replacement battery without the aid of some device.

Examples described herein provide a battery replacement device. The battery replacement device may include a body, an alignment guide coupled to the body to fit around a portion of an electrical device to guide the battery replacement device in alignment with the electrical device, a battery coupling device formed at a first portion of the body to couple to a used battery of the electrical device, and a recess defined in a second portion of the body to retain a replacement battery. The battery replacement device may include a void defined within the body. The void may be aligned with a fastener within the electrical device used to fasten the replacement battery to the electrical device.

The alignment guide comprises a border extending from both sides of the body and around a perimeter of the body. The border forms a recess on each side of the body such that the sides of the body interface with the electrical device as the border interfaces with an outer perimeter of a housing of the electrical device. The border may be dimensioned to create a transition fit between the border and the electrical device.

The battery coupling device may include an adhesive pad. The adhesive pad may include a first side, and a second side opposite the first side. The second side couples the adhesive pad to the body. An adhesive layer is coupled to the first side. Further, a release liner may be removably coupled to the adhesive layer. The battery coupling device may include a retention snap to couple the used battery of the electrical device to the first portion of the body. The battery replacement device may also include a plurality of orientation guides extending from the body to define an application orientation of the battery replacement device.

Examples described herein also provide a battery replacement system. The battery replacement system may include a body, and an alignment guide coupled to the body to fit around a portion of an electrical device to guide the battery replacement system in alignment with the electrical device. The battery replacement system may also include an adhesive pad coupled to a first portion of the body, and a replacement battery removably coupled to a second portion of the body. The replacement battery may protrude from a surface of the body and may be located on the body such that when the battery replacement system is coupled to the electrical device, the replacement battery is seated within a battery compartment of the electrical device.

The adhesive pad may include a first side, and a second side opposite the first side. The second side couples the adhesive pad to the body. Further, the adhesive pad may include an adhesive layer coupled to the first side of the adhesive pad, and a release liner removably coupled to the adhesive layer.

The replacement battery may be removably coupled to the second portion of the body using a replacement battery coupling device. Further, a housing may be formed in the body to surround a portion of the replacement battery. The replacement battery may include a captive screw to couple the replacement battery to the electrical device.

Examples described herein also provide a battery replacement device. The battery replacement device may include a body, a battery coupling device formed at a first portion of the body to couple to a used battery of the electrical device, a recess defined in a second portion of the body to retain a replacement battery, and a plurality of orientation guides extending from the body to define an application orientation of the battery replacement device. The battery replacement device may include an alignment guide coupled to the body to create a transition fit around a portion of an electrical device to guide the battery replacement device in alignment with the electrical device.

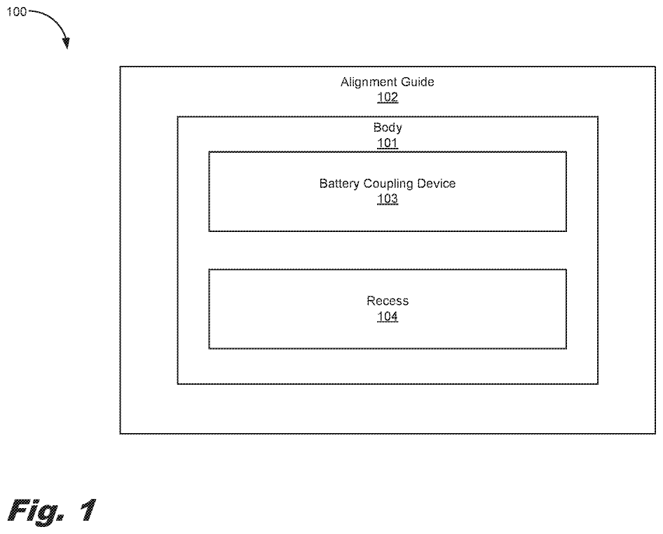

Turning now to the figures, FIG. 1 is a block diagram of a battery replacement device (100), according to an example of the principles described herein. The battery replacement device (100) includes a body (101), and an alignment guide (102) coupled to the body (101) to fit around a portion of an electrical device to guide the battery replacement device (100) in alignment with the electrical device. The battery replacement device (100) further includes a battery coupling device (103) formed at a first portion of the body (101) to couple to a used battery of the electrical device. As used in the present specification and in the appended claims, the term “used battery” is meant to be understood broadly as a battery that is installed in an electrical device that is intended to be replaced by a replacement battery. The battery replacement device (100) also includes a recess (104) defined in a second portion of the body (101) to retain a replacement battery. More details regarding the battery replacement device (100) are provided herein. In one example, the battery replacement device (100) may be made from, for example, a non-conductive material. In one example, the battery replacement device (100) may be made from, for example, injection molded plastic or another rigid and recyclable material,

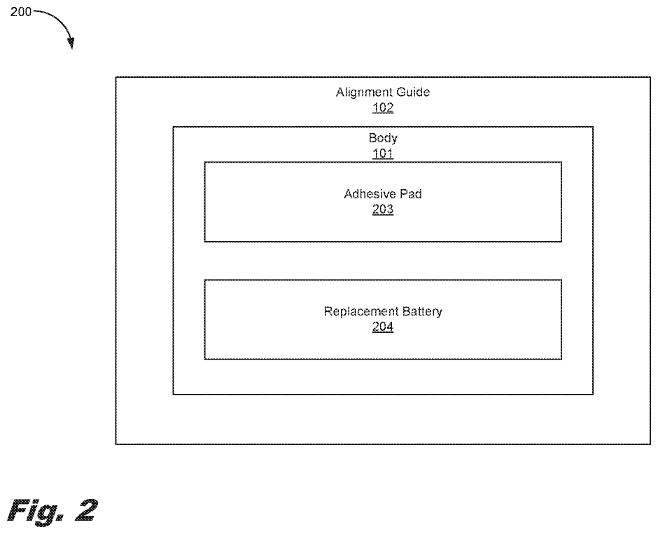

FIG. 2 is a block diagram of a battery replacement system (200), according to an example of the principles described herein. The battery replacement system (200) may include a body (101), and an alignment guide (102) coupled to the body to fit around a portion of an electrical device to guide the battery replacement system in alignment with the electrical device. The battery replacement system (200) may also include an adhesive pad (203) coupled to a first portion of the body (101). The adhesive pad (203) may be used to extract a used battery from a target electrical device. A replacement battery (204) may also be included in the battery replacement system (200). The replacement battery (204) may be removably coupled to a second portion of the body (101). More details regarding the battery replacement system (200) are provided herein.

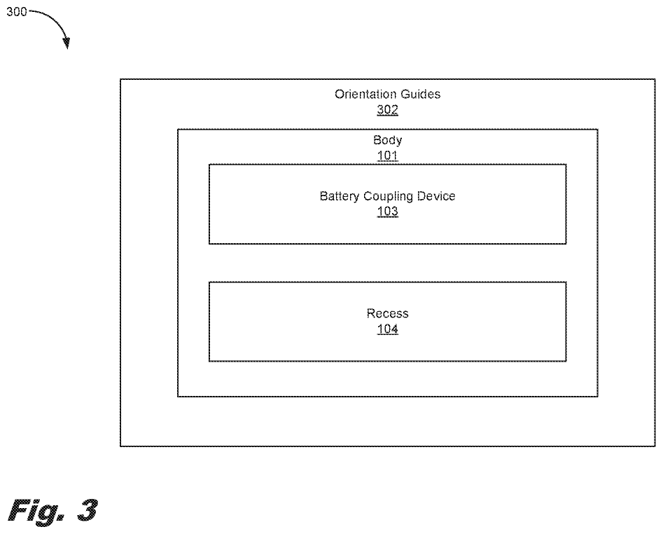

FIG. 3 is a block diagram of a battery replacement device (300), according to another example of the principles described herein. The battery replacement device (300) of FIG. 3 may include a body (101), and a battery coupling device (103) formed at a first portion of the body (101) to couple to a used battery of a target electrical device to the battery replacement device (300). The battery replacement device (300) may also include a recess (104) defined in a second portion of the body (101) to retain a replacement battery. Further, battery replacement device (300) may also a plurality of orientation guides (302) extending from the body (101) to define an application orientation of the battery replacement device (300) relative to the target electrical device. More details regarding the battery replacement device (300) are provided herein.

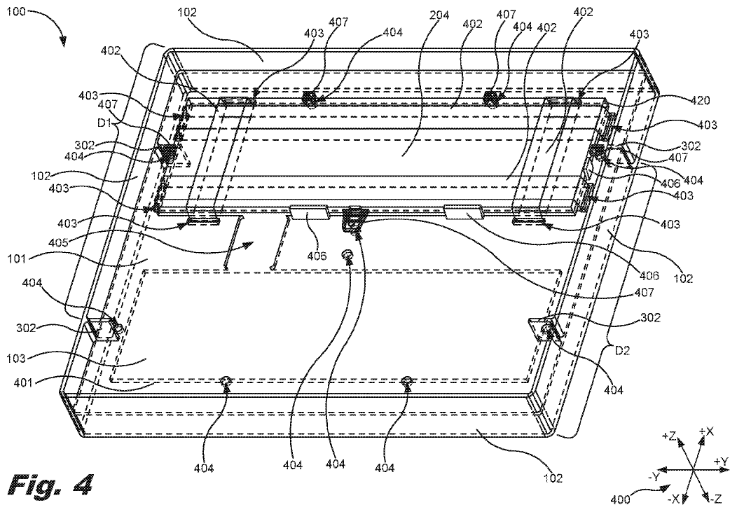

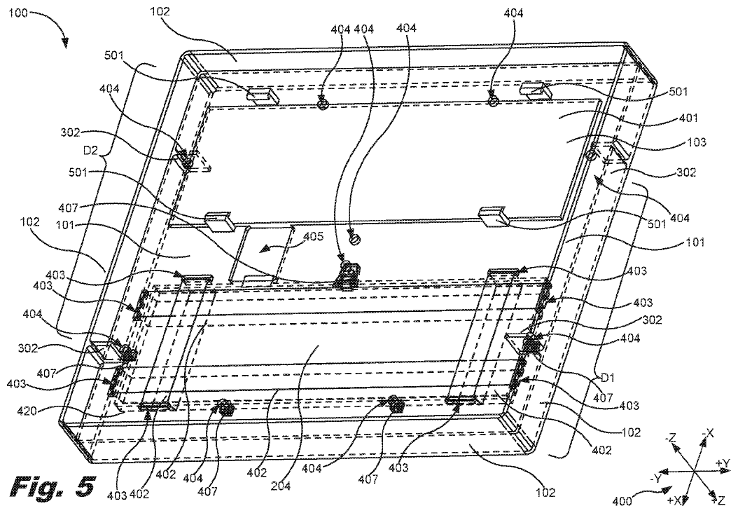

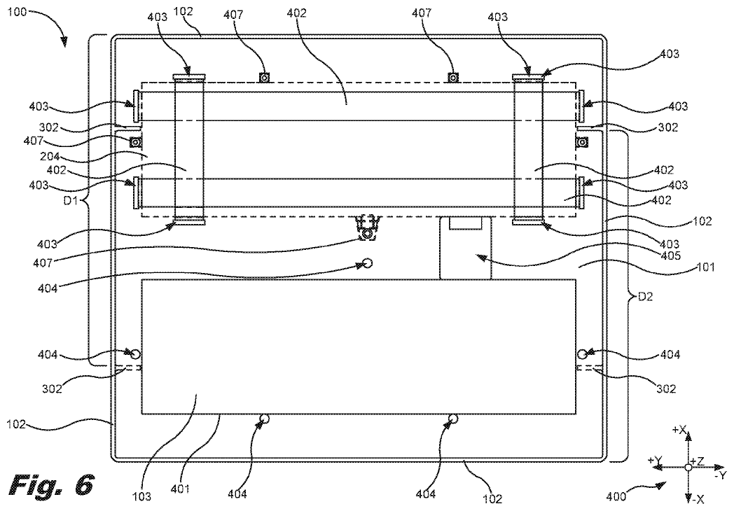

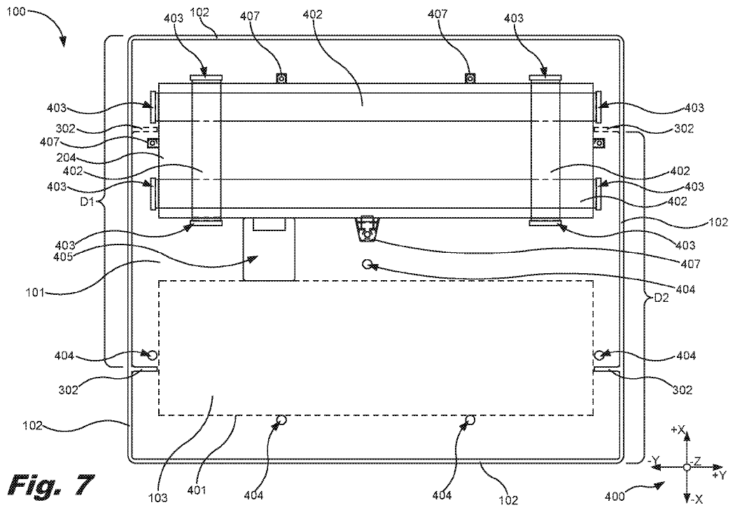

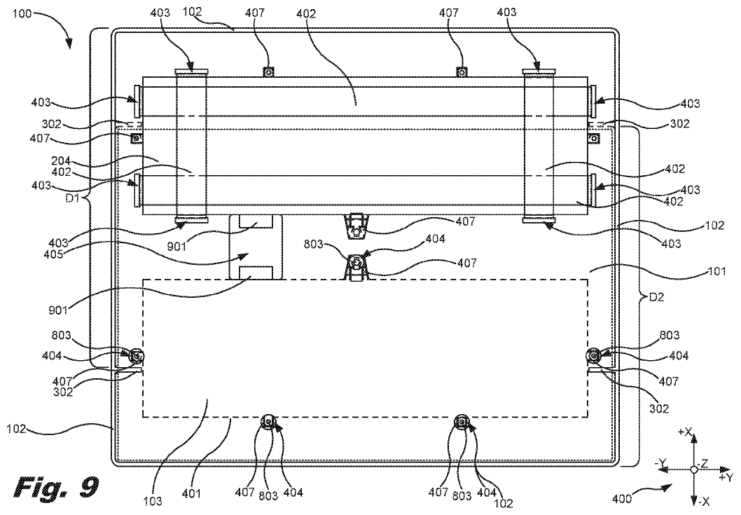

FIG. 4 is an isometric view of a battery replacement device (100, 300, collectively referred to herein as 100), according to an example of the principles described herein. FIG. 5 is an isometric view of a battery replacement device (100), according to an example of the principles described herein. FIG. 6 is a top plan view of a battery replacement device (100), according to an example of the principles described herein. FIG. 7 is a bottom plan view of a battery replacement device (100), according to an example of the principles described herein. FIGS. 4 through 7 depict the battery replacement device (100) in various orientations. FIGS. 9 through 13 depict a manner in which the battery replacement device (100) may be used in connection with a target electronic device. FIGS. 4 through 13 will be described with the aid of a coordinate indicator (400). The coordinate indicator (400) indicates all three coordinate directions and includes a positive and negative direction for each coordinate direction. In instances where a circle is included in the coordinate indicator (400), that circle indicates movement into the drawing page, and the associated designation of, for example, +Z indicates that the Z-direction moves in the positive direction into the drawing page.

With reference to FIGS. 4 through 7, the battery replacement device (100) includes a body (101) or center portion that is used to hold both a used battery removed from a target electrical device and a replacement battery used to replace the used battery. An alignment guide (102) is coupled to or formed as a monolithic portion of the body (101) and extends from the body in the positive and negative Z-directions as indicated by the coordinate indicator (400). In this manner, a recess is formed between the alignment guide (102) and the body (101), and the body (101) and alignment guide (102) are dimensioned to fit around a housing or other portion of a target electrical device from which a used battery is to be extracted and replaced with a replacement battery. In one example, the body (101) and alignment guide (102) are dimensioned to fit around a housing or other portion of a target electrical device in at least one coordinate direction. The alignment guide (102) acts as a border that is dimensioned to create a transition fit between the alignment guide (102) and the target electrical device such that a user can easily couple and decouple the battery replacement device (100) to the target electrical device, but still provide for a tolerant level of alignment with the target electrical device.

The alignment guide (102) serves to align a battery coupling device (103) such as the adhesive pad (203) referred to herein in connection with FIG. 2 with a battery disposed within a battery compartment of the target electrical device in order to couple the used battery within the battery compartment of the target electrical device to the body (101) of the battery replacement device (100). As is described herein, this coupling of the used battery to the body (101) of the battery replacement device (100) is performed without a user of the battery replacement device (100) touching the used battery. This provides safety to the user since the user never has an opportunity to come into contact with, for example, the used Li-poly battery that may otherwise cause harm to the user if mishandled.

In one example, the battery coupling device (103) may include the adhesive pad (203) referred to herein in connection with FIG. 2. In this example, the adhesive pad (203) maybe coupled to the body (101) using an adhesive or other coupling method or device at a first side of the adhesive pad (203). The adhesive pad (203) may include an adhesive layer on a second side of the adhesive pad (203) away from the body (101). A release liner (401) maybe coupled to the adhesive layer to ensure that the adhesive layer does not prematurely stick to other objects before being used to couple the used battery to the battery coupling device (103). The release liner (401) may be, for example, a paper or plastic-based film sheet that may be applied during the manufacturing process and used to prevent a sticky surface such as the adhesive layer of the adhesive pad (203) from prematurely adhering. The release liner (401) may be coated on one or both sides with a release agent, which provides a release effect against the adhesive layer.

In another example, the battery coupling device (103) may include a number of retention snaps (501) as depicted in FIG. 5. The retention snaps (501) may be elastically biased to capture the used battery and secure the used battery to the body (101) of the battery replacement device (100) as the battery replacement device (100) is engaged with the target electrical device. The retention snaps (501) may be present on the body (101) of the battery replacement device (100) on both the receiving side of the battery replacement device (100) where the old battery is captured by the battery replacement device (100), and the deployment side of the battery replacement device (100) where the replacement battery (204) is seated until it is coupled to the target electrical device. On the receiving side of the battery replacement device (100), the retention snaps (501) couple to the old battery when the battery replacement device (100) is aligned with and coupled to the electrical device, the fasteners and electrical coupling that couple the old battery to the electrical device are removed, and the battery replacement device (100) is decoupled from the electrical device removing he old battery from a battery compartment of the electrical device. Further, on the deployment side of the battery replacement device (100), once the fasteners are engaged to secure the replacement battery (204) to the electrical device, the retention snaps (501) may decouple from the replacement battery (204) when the battery replacement device (100) is decoupled from the electrical device. In this example, the force provided by the fasteners used to retain the replacement battery (204) in the battery compartment of the electrical device may exceed the force of the retention snaps (501) used to secure the replacement battery (204) to the battery replacement device (100), and, therefore, the replacement battery(204) may be decoupled from the battery replacement device (100).

The battery coupling device (103) may also include a replacement battery (204) coupled to the body (101) on a separate portion of the body (101) with respect to the battery coupling device (103). In one example, the replacement battery (204) may be coupled to an opposite side of the body (101) relative to the battery coupling device (103) in the z-directions, coupled to an opposite end of the body (101) relative to the battery coupling device (103) in the x-directions, or combinations thereof. In the example of FIGS. 4 through 13, the replacement battery (204) is coupled to an opposite side and an opposite end of the body (101) relative to the battery coupling device (103). This example allows a user to simply rotate the battery coupling device (103) about the y-axis between the removal of the used battery from the target electrical device and the seating of the replacement battery (204) into a battery compartment of the target electrical device.

The replacement battery (204) may be coupled to the body (101) of the battery replacement device (100) using any fastening devices that allow for the replacement battery (204) to be decoupled from the battery replacement device (100) when the replacement battery (204) is seated within a battery compartment of the target electrical device. In one example, as depicted in FIGS. 4 through 13, the replacement battery (204) is coupled to the body (101) of the battery replacement device (100) using a number of tapes (402) wrapped around the replacement battery (204) and a portion of the body (101) of the battery replacement device (100). For example, the body (101) may include tape voids (403) through which the tapes (402) are extended and wrapped around the body (101) and the replacement battery (204) to secure the replacement battery (204) to the body (101). Even though the example of tapes (402) and tape voids (403) has been described herein, any coupling device may be used to allow the replacement battery (204) to be secured to the body (101), while allowing for the replacement battery (204) to be removed from the body (101).

The body (101) may include a number of fastener voids (404) defined therein associated with both the battery coupling device (103) and the replacement battery (204) to provide for a user to access a number of fasteners used to fasten the used battery and the replacement battery (204) (when seated in the battery compartment of the target electrical device) and engage or disengage those fasteners to allow for the coupling or decoupling of the used battery and the replacement battery (204) to and from the target electrical device. In one example, the fastener voids (404) may be circular voids that allow for the shaft of a screw driver to enter the fastener voids (404) and interact with a screw. In one example, the battery replacement device (100) may include as many fastener voids (404) and in any pattern as may match the location of corresponding fasteners used to secure the used battery and the replacement battery (204) to the electrical device.

The body (101) may include a connector void (405) defined therein to allow for a user to access an electrical connector used to electrically couple the used battery or replacement battery (204) to the target electrical device. The connector void (405) allows the user to disconnect the used battery when it becomes time to replace the old battery, and connect the replacement battery (204) when the replacement battery (204) is seated in the battery compartment. In one example, the battery replacement device (100) may include as many connector void (405) and in any pattern as may match the location of corresponding electrical connectors used to electrically couple the used battery and the replacement battery (204) to the electrical device.

In another example of the battery replacement device (100) of FIGS. 4 through 13, the used battery and the replacement battery (204) may include a drop-in form factor where the electrical coupling of the used battery and the replacement battery (204) to the target electrical device may be achieved by correct seating of the used battery and the replacement battery (204) into a battery compartment of the target electrical device without electrical coupling of an electrical connector by a user. In this example, the drop-in form factor connector may be a blind mate connector. In this example, the connector void (405) may be included to allow a user to confirm that the electrical connections of the used battery and the replacement battery (204) are properly connected to the electrical connections of the target electrical device.

A number of orientation guides (302) may be coupled to or formed as a monolithic portion of the body (101) and/or the alignment guide (102). The orientation guides (302) may be placed along a length of the battery replacement device (100) in the positive and negative x-directions. For example, a first set of orientation guides (302) may be located on the same side of the body (101) on which the replacement battery (204) is coupled, but on an opposite end of the body (101) relative to the replacement battery (204). The distance (D1) between the end of the battery replacement device (100) at the positive x-direction as indicated by the coordinate indicator (400), and the location of the orientation guides (302) on the same side of the body (101) on which the replacement battery (204) is coupled may be dimensioned to fit a first dimension of a housing or other part of a target electrical device. Similarly, a second set of orientation guides (302) may be located on the same side of the body (101) on which the battery coupling device (103) is coupled, but on an opposite end of the body (101) relative to the battery coupling device (103). The distance (D2) between the end of the battery replacement device (100) at the negative x-direction as indicated by the coordinate indicator (400), and the location of the orientation guides (302) on the same side of the body (101) on which the battery coupling device (103) is coupled may dimensioned to fit the first dimension of a housing or other part of a target electrical device. In this manner, the orientation guides (302) act to deny mis-orientation and mis-engagement of the battery replacement device (100) with respect to and with the target electrical device. This assures that a user does not incorrectly orient the battery replacement device (100) incorrectly and can succeed in replacing the used battery with the replacement battery (204).

In one example, the body (101) and alignment guide (102) of the battery replacement device (100) may be made of a transparent material such as a transparent plastic material. In this example, the user may be able to orient the battery replacement device (100) relative to the target electrical device by using the transparency provided by the transparent material. In one example of the battery replacement device (100) of FIGS. 4 through 13, the battery replacement device (100) may include both the orientation guides (302) and the transparent material so that the user may have both the transparent material to see how the battery replacement device (100) aligns with the target electrical device as well as the orientation guides (302) to ensure that the user does not incorrectly orient the battery replacement device (100) with respect to the target electrical device.

In one example, the replacement battery (204) may be housed within a recess formed in the body (101) or protected by a separate casing (420) that prevents destruction to the replacement battery (204) at any time during the installation of the replacement battery (204). For example, the recess or casing (420) may protect the replacement battery (204) when a user cuts the tapes (402) wrapped around the replacement battery (204) and a portion of the body (101) to release the replacement battery (204) from the body (101) during the installation of the replacement battery (204) into a battery compartment of the target electrical device.

The replacement battery (204) and used battery may also include a number of fastener brackets (407). The fastener brackets (407) are coupled to the replacement battery (204) and old battery, and are used to secure the replacement battery (204) and used battery to the target electrical device using, for example, screws or other fasteners. In one example, the fastener brackets (407) may be captive fasteners in which the fastener is permanently held within the fastener brackets (407) including during servicing of the replacement battery (204) and old battery. A captive fastener provides for the coupling of the replacement battery (204) and used battery to the electrical device while avoid the possibility of loosing or damaging the fastener itself. For example, the captive fastener that is the fastener brackets (407) may include a captive screw that is permanently coupled to the fastener brackets (407) to provide the user with the ability to couple and decouple the replacement battery (204) and used battery to and from the electrical device while not losing the screws.

The battery replacement device (100) may also include a number of battery guides (406) as depicted in FIG. 4. The battery guides (406) prevent the battery replacement device (100) from being used in an improperly oriented manner. The battery guides (406) may be dimensioned to fit between the replacement battery (204) and used battery and a battery compartment of the target electrical device, and may provide the user with haptic feedback as the user couples the battery replacement device (100) to the target electrical device. As the user does so, the user may feel the engagement of the battery guides (406) into the target electrical device, whereas no such sensation would be felt if the battery replacement device (100) were improperly oriented. Thus, the battery guides (406) act as another protection against mis-orientation or misalignment of the battery replacement device (100) with respect to the target electrical device.

The dimensions, sizes, and locations of the various elements of the battery replacement device (100) as described in connection with FIGS. 4 through 7 may vary depending on the target electrical device for which the battery replacement device (100) is to be used. For example, the height, width, and depth of the battery replacement device (100) may be different for a battery replacement device (100) manufactured for and used in connection with a laptop computing device with respect to a battery replacement device (100) manufactured for and used in connection with a smartphone device since the sizes, dimensions, and locations of battery compartments for a laptop computing device is different for a smartphone device. Thus, the battery replacement device (100) may be manufactured to fit and interact with a wide variety of form factors, types of electrical devices, and models of electrical devices.

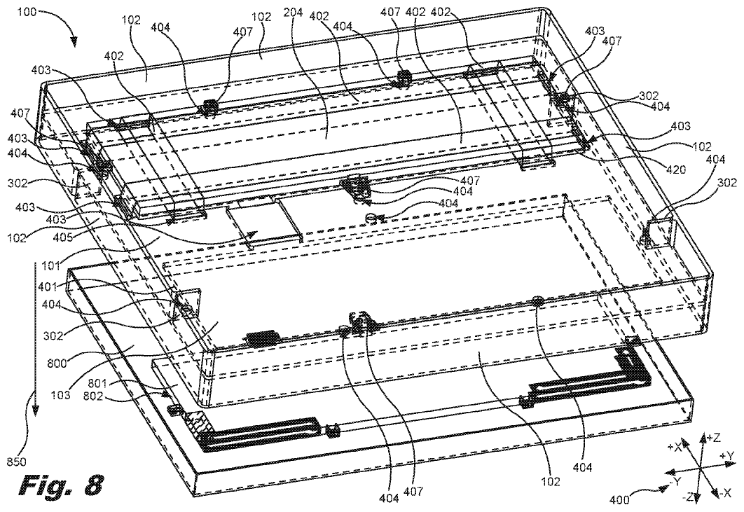

FIGS. 8 through 13 depict the method by which the battery replacement device (100) is used to replace and used battery with a replacement battery (204). FIG. 8 is an isometric view of the battery replacement device (100) being used in connection with an electrical device (800) to remove a used battery (801) of the electrical device (800) before removal of the used battery (801), according to an example of the principles described herein. In one example, the battery replacement device (100) may be sent to a user in a package for the user to replace the used battery (801). Once the user opens the packaging and obtains the battery replacement device (100), the user may begin by removing a cover to the electrical device (800) to expose a battery compartment (802) and used battery (801) of the electrical device (800). The battery compartment (802) may be any recess within the electrical device (800) that houses the used battery (801) and can house the replacement battery (204).

In an example where an adhesive pad (203) is used as the battery coupling device (103), the user may remove the associated release liner (401) from the adhesive pad (203) in preparation for the adhesive layer of the adhesive pad (203) coupling with the used battery (801). The battery replacement device (100) may then be interfaced with the electrical device (800) by moving the battery replacement device (100) in the direction of arrow (850) and allowing the alignment guide (102) to fit around the perimeter of the electrical device (800). Instructions may be provided to the user that instruct the user as to the correct orientation of the battery replacement device (100) with respect to the electrical device (800). However, the user may easily identify an improper alignment or orientation of the battery replacement device (100) with respect to the electrical device (800) using the orientation guides (302).

FIG. 9 is a plan view of the battery replacement device (100) being used in connection with the electrical device (800) to remove the used battery (801) of the electrical device (800) before removal of the used battery (801), according to an example of the principles described herein. As depicted in FIG. 9, the dashed outline of the outer perimeter of the electrical device (800) is depicted as fitting in the positive and negative y-directions along the length of the battery replacement device (100), and between the bottom of the battery replacement device (100) in the negative x-direction up to the orientation guides (302) located juxtaposition to the replacement battery (204) and in the positive x-direction. In this manner, the alignment guide (102) and orientation guides (302) are dimensioned to create a transition fit between the housing of the electrical device (800) and the battery replacement device (100).

In this coupled state, the fastener voids (404) defined in the battery replacement device (100) align with a number of fasteners (803) and fastener brackets (407) that are used to couple the used battery (801) to the electrical device (800) within the battery compartment (802). The user may then access the fasteners (803) to remove them from engagement with the electrical device (800) and decouple the used battery (801) from the electrical device (800). Further, in examples where the used battery (801) includes an electrical connector (901), the user may decouple the electrical connector (901) of the used battery (801) from a mating connector of the electrical device (800) by accessing the mating electrical connectors via the connector void (405).

Because the release liner (401) from the adhesive pad (203) has been removed exposing the adhesive layer of the adhesive pad (203), and because that adhesive layer is now in contact with the used battery (801), the used battery (801) is now coupled to the battery replacement device (100). In this state, the battery replacement device (100) may be decoupled from the electrical device (800). Further, in examples where the battery replacement device (100) includes retention snaps (501) as depicted in FIG. 5, the movement of the battery replacement device (100) in the direction of arrow (850), and in an engaged state with the housing of the electrical device (800), the retention snaps (501) deflect around the used battery (801). Using the elastic deformation properties of the material of the battery replacement device (100) and its retention snaps (501), the retention snaps (501) are allowed to recover from the deformation after the stress field of the deflection has been removed.

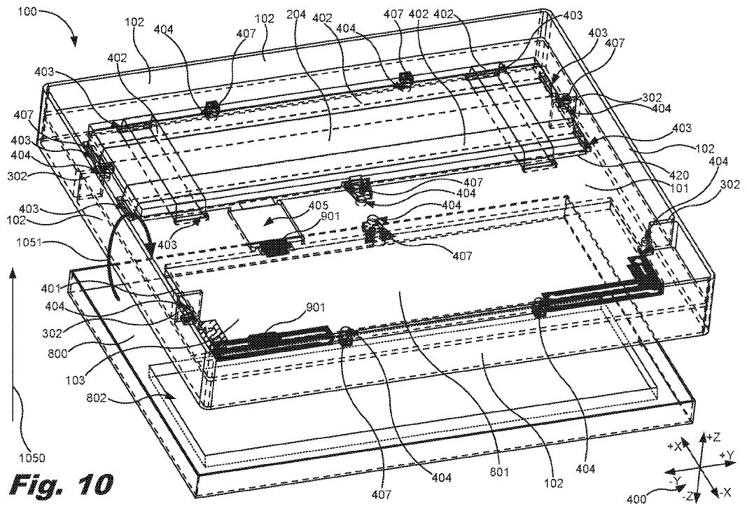

In FIG. 10, the battery replacement device (100) is decoupled from the electrical device (800). FIG. 10 is an isometric view of the battery replacement device (100) being used in connection with an electrical device (800) to remove the used battery (801) of the electrical device (800) after removal of the used battery (800), according to an example of the principles described herein. The user does not touch the used battery (801) while removing it from the electrical device (800) which provides an increase in safety to the user since the user does not have the potential to be exposed to chemicals and other hazards associated with the used battery (801). Once the used battery (801) is coupled to the battery replacement device (100) via the adhesive pad (203), the battery replacement device (100) may be decoupled from the electrical device (800) by moving the battery replacement device (100) in the direction of arrow (1050). It is noted that the battery compartment (802) is fully depicted in FIG. 10, and is void of a battery.

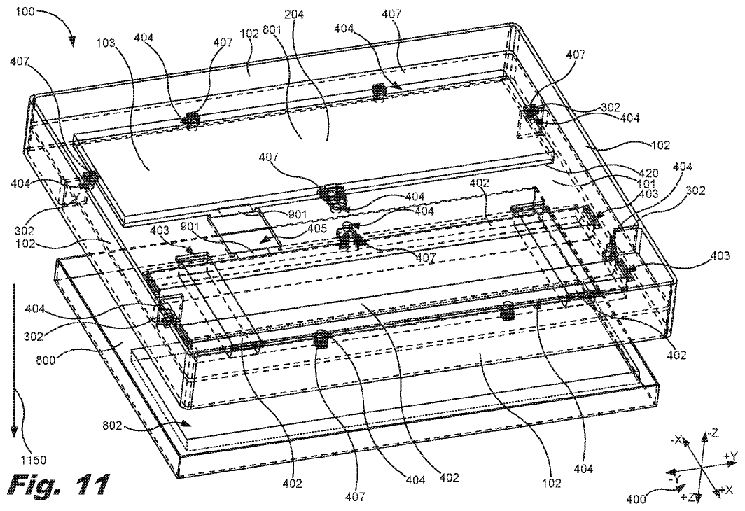

In FIG. 10, a rotational arrow (1051) is depicted to indicate the manner in which the battery replacement device (100) is to be rotated about the y-axis as indicated by the coordinate indicator (400) in preparation for the installation of the replacement battery (204) into the electrical device (800). FIG. 11 is an isometric view of the battery replacement device (1000 being used in connection with the electrical device (800) to replace the used battery (801) of the electrical device (8000 with a replacement battery (204), and depicts the battery replacement device (100) before seating of the replacement battery (204) into the battery compartment (802) of the electrical device (800), according to an example of the principles described herein. Once the battery replacement device (100) is rotated about the y-axis as indicated by rotational arrow (1051), the battery replacement device (100) may be moved in the direction of arrow (1150) to re-engage the battery replacement device (100) with the electrical device (800).

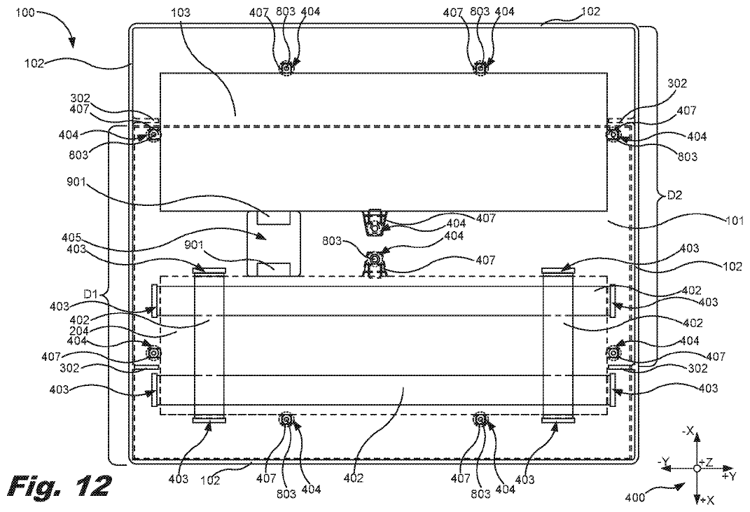

FIG. 12 is a plan view of the battery replacement device (100) being used in connection with an electrical device (800) to replace the used battery (801) of the electrical device, now coupled to the battery replacement device (100), with the replacement battery (204) and depicts seating of the replacement battery (204) into the battery compartment (802) of the electrical device (800), according to an example of the principles described herein. As depicted in FIG. 12, the dashed outline of the outer perimeter of the electrical device (800) is depicted as fitting in the positive and negative y-directions along the length of the battery replacement device (100), and between the bottom of the battery replacement device (100) in the positive x-direction up to the orientation guides (302) located juxtaposition to the adhesive pad (203) and used battery (801) coupled to the body (101) of the battery replacement device (100) and in the negative x-direction. In this manner, the alignment guide (102) and orientation guides (302) are dimensioned to create a transition fit between the housing of the electrical device (800) and the battery replacement device (100). Further, in examples that include battery guides (406) as depicted in FIG. 4, the user may be able to align the battery guides (406) with the battery compartment (802) through hepatically sensing the engagement of the battery guides (406) with the battery compartment (802).

In this coupled state, the fastener voids (404) defined in the battery replacement device (100) align with a number of fasteners (803) and fastener brackets (407) that are used to couple the replacement battery (204) to the electrical device (800) within the battery compartment (802). The user may then access the fasteners (803) to engage them with the fastener brackets (407) and electrical device (800) and couple the replacement battery (204) to the electrical device (800). Further, in examples where the replacement battery (204) includes an electrical connector, the user may couple the electrical connector of the replacement battery (204) to a mating connector of the electrical device (800) by accessing the mating electrical connectors via the connector void (405).

The user may then be instructed to decouple the replacement battery (204) from the battery replacement device (100) by cutting or otherwise removing the tapes (402) wrapped around the replacement battery (204) and a portion of the body (101) of the battery replacement device (100). In one example, the replacement battery (204) may be housed within a recess formed in the body (101) or protected by a separate casing (420) that prevents destruction to the replacement battery (204). In this manner, as the user cuts the tapes (402), the user will not damage the replacement battery (204) by puncturing or deforming the replacement battery (204). The tapes (402), when cut, may be pulled from underneath and around the replacement battery (204) through the tape voids (403) and disposed of.

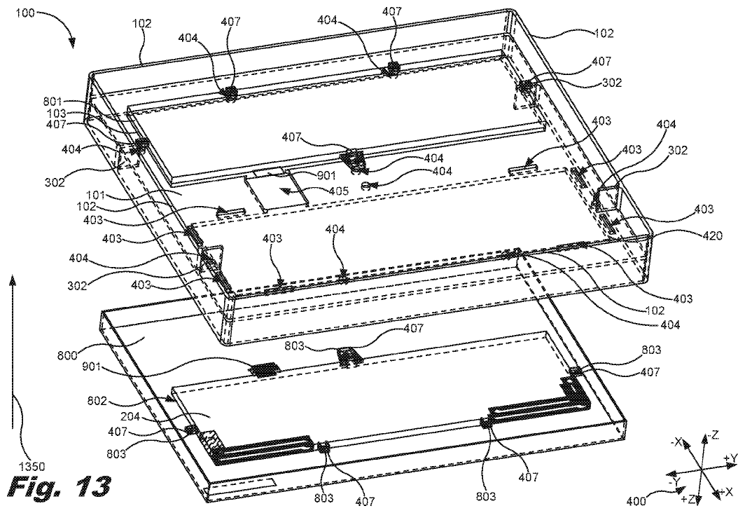

FIG. 13 is an isometric view of the battery replacement device (100) being used in connection with an electrical device (800) to replace the used battery (801) of the electrical device (800) with the replacement battery (204), and depicts seating of the replacement battery (204) and removal of the battery replacement device (100) from the electrical device (800), according to an example of the principles described herein. The battery replacement device (100) is removed from the electrical device (800) by moving the battery replacement device (100) in the direction of arrow (1350) and decoupling the alignment guide (102) from the housing of the electrical device (800).

With the used battery (801) replaced with the replacement battery (204), the user may then recouple the cover of the electrical device (800) to house the replacement battery (204) within the electrical device (800). Further, with the used battery (801) coupled to the battery replacement device (100), the user may be instructed to replace the battery replacement device (100) into its original packaging or another packaging to send on to a recycling facility in order to safely and environmentally dispose of the used battery (801).

Throughout this description, the used battery (801) and the replacement battery (204) maybe soft pack, Li-poly batteries that are not themselves housed in a rigid housing. Thus, the ability to remove and replace the batteries (204, 801) without a user coming into contact with the batteries (204, 801) increases the user's safety. Further, in one example, the battery replacement device (100) may be made of a recyclable material. In this example, the ability to used recycled material in the battery replacement device (100) and the ability to recycle the battery replacement device (100) is environmentally friendly.

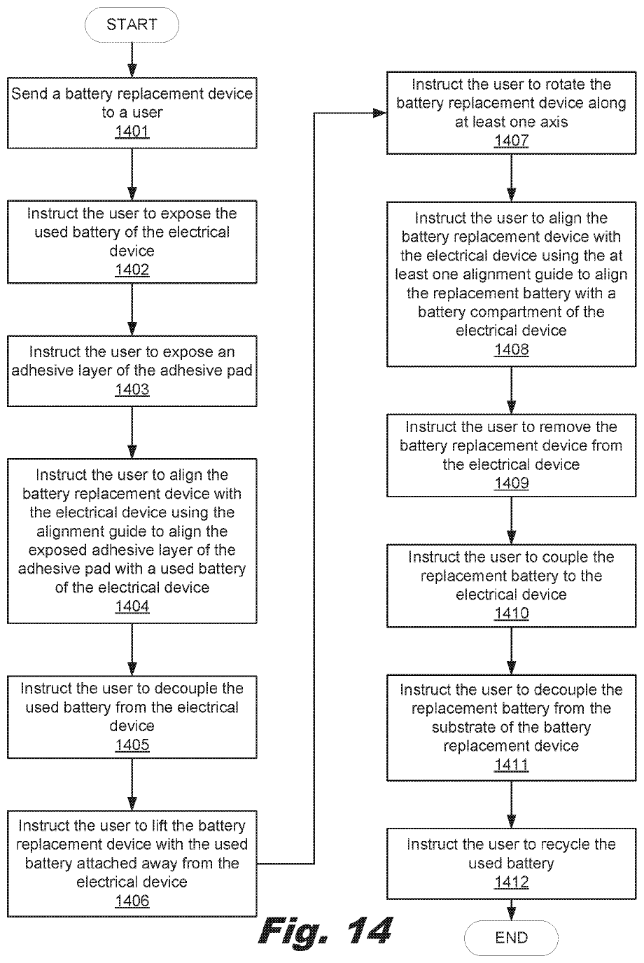

FIG. 14 is a flowchart (1400) showing a method of replacing a battery (204, 801) in an electrical device (800), according to an example of the principles described herein. The method may be performed by instructing a user via a set of instructions on how to replace the batteries (204, 801). The method may begin by sending (block 1401) a battery replacement device (100) to a user. The battery replacement device (100) includes those elements described above in connection with FIGS. 1 through 13. The user may be instructed to expose (block 1402) the used battery (801) of the electrical device (800) by, for example, removing an access panel from the electronic device (800) under which the use battery (801) is located.

The user may be instructed to expose (block 1403) an adhesive layer of the adhesive pad (203). This may be performed by removing the release liner (401) of the adhesive pad (203) and exposing an adhesive layer that is to be coupled to the used battery (801). The user may be instructed to align (block 1404) the battery replacement device (100) with the electrical device (800) using the alignment guide (102) to align the exposed adhesive layer of the adhesive pad (203) with the used battery (801) of the electrical device (800).

The user may be instructed to decouple (block 1405) the used battery (801) from the electrical device (800). In one example, the user may also be instructed to remove a number of fasteners (803) from the electrical device (800) and/or disconnect an electrical connector from the electrical device (800) to mechanically and electrically separate the used battery (801) from the electrical device (800).

The user may be instructed to lift (block 1406) the battery replacement device (100) with the used battery (801) attached away from the electrical device (800). The user may be instructed to rotate (block 1407) the battery replacement device (100) along at least one axis, and, in the examples described herein, along the y-axis as indicated by the coordinate indicator (400). This rotation orients the battery replacement device (100) such that the replacement battery (204) is ready to be aligned with a battery compartment (802) of the electronic device (800).

The user is instructed to align (block 1408) the battery replacement device (100) with the electrical device (800) using the alignment guide (200) to align the replacement battery (204) with the battery compartment (802) of the electrical device (800). The user may be instructed to remove (block 1409) the battery replacement device (100) from the electrical device (800).

Further, the user may be instructed to couple (block (1410) the replacement battery (204) to the electrical device (800). In one example, this may be accomplished by coupling a number of fasteners (803) from the electrical device (800) and/or connecting an electrical connector to the electrical device (800) to mechanically and electrically couple the replacement battery (204) to the electrical device (800). The user may be instructed to decouple (block 1411) the replacement battery (204) from the body (101) of the battery replacement device (100).

Further, in one example, the user may be instructed to recycle (block 1412) the used battery (801) by, for example, placing the battery replacement device (100) with the used battery (801) coupled thereto into packaging for delivery to a recycling facility. In one example, the packaging may be prepaid delivery packaging.

The examples described herein may also be incorporated as a kit for replacing a battery. The battery replacement kit may include the battery replacement device (100) described herein. The battery replacement device (100) may include a body (101), an alignment guide (102) coupled to the body (101) to fit around at least a portion of an electrical device to guide the battery replacement device (101) in alignment with the electrical device (800), a battery coupling device (103) formed at a first portion of the body (101), and a replacement battery (204) removably coupled to a second portion of the body (101). Further, in one example, the battery replacement kit may include packaging to send the battery replacement device (101) to another location such as a recycling facility after the user has successfully replaced the used battery (801) with the replacement battery (204). In this example, the packaging may be prepaid delivery packaging, may be the same packaging used to send the battery replacement device (100) to the user, may be additional packaging included in the original packaging, or combinations thereof.

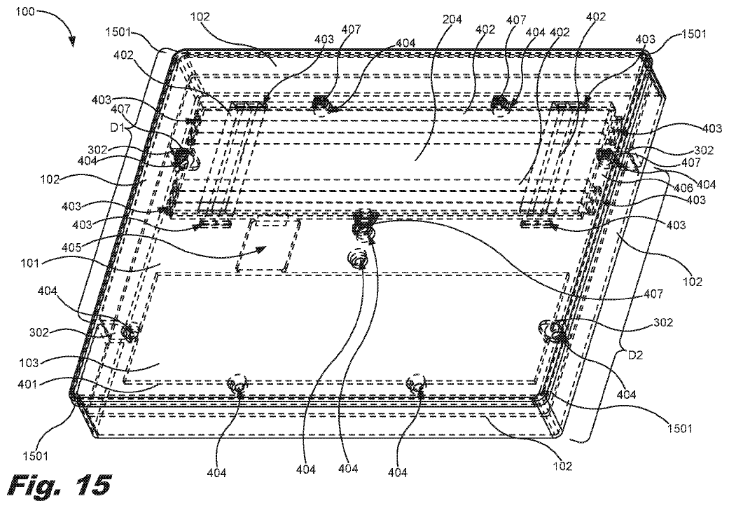

FIG. 15 is an isometric view of the battery replacement device (100) including a lid (1501), according to an example of the principles described herein. As the user has the potential to touch the replacement battery (204) or the used battery (801) when they are coupled to the battery replacement device (100), a lid (1501) may be provided to ensure that the user cannot access the batteries (204, 801) directly. In one example, the battery replacement device (100) may be provided with one lid (1501). In this example, the user may be instructed to remove and replace the lid (1501) based on where the battery, either the replacement battery (204) or the old battery, is located. This precludes the user from accidentally coming into contact with the batteries (204, 801).

In another example, two lids (1501) may be provided to the user. In this example, a first lid (1501) may be used to cover the replacement battery (204) before it is installed in the electrical device. At the point at which the user is to install the replacement battery (204), the user may be instructed to remove the lid (1501) and align the battery replacement device (100) with the electrical device as described herein. Further, in this example, a second lid (1501) may be provided to cover the used battery (801) after it is extracted from the battery compartment (802) of the electrical device (800). The user may be instructed to couple the lid (1501) to the side of the battery replacement device (100) on which the used battery (801) is located after the used battery (801) is decoupled from the electrical device (800) and coupled to the battery replacement device (100).

In one example, the lid (1501) may be coupled to the alignment guide (102) of the battery replacement device (100) using a transition fit between an exterior portion of the alignment guide (102) and an interior portion of the lid (1501) where mild force is applied to couple and decouple the lid (1501) to and from the battery replacement device (100). In another example, the lid (1501) may be coupled to the battery replacement device (100) using a number of fasteners.

The specification and figures describe a battery replacement device that includes a body, and an alignment guide coupled to the body to fit around a portion of an electrical device to guide the battery replacement device in alignment with the electrical device. The battery replacement device also includes a battery coupling device formed at a first portion of the body to couple to a used battery of the electrical device, and a recess defined in a second portion of the body to retain a replacement battery.

This battery replacement device may provide for otherwise non-serviceable soft-pack batteries to be user-serviceable resulting in fewer technician costs for a product seller and an end user. Further, the battery replacement device provides a lower likelihood of battery failure during replacement, and provides a more secure packaging during battery shipment. Still further, system downtime may be reduced during a battery failure using the methods and devices described herein.

The preceding description has been presented to illustrate and describe examples of the principles described. This description is not intended to be exhaustive or to limit these principles to any precise form disclosed. Many modifications and variations are possible in light of the above teaching.

What is claimed is:

1. A battery replacement device, comprising:
a body;
an alignment guide coupled to the body to fit around a portion of an electrical device to guide the battery replacement device in alignment with the electrical device;
a battery coupling device formed at a first portion of the body to couple to a used battery of the electrical device; and
a recess defined in a second portion of the body to retain a replacement battery.

2. The battery replacement device of claim 1, comprising a void defined within the body, the void being aligned with a fastener within the electrical device used to fasten the replacement battery o the electrical device.

3. The battery replacement device of claim 1, wherein the alignment guide comprises a border extending from both sides of the body and around a perimeter of the body, the border forming a recess on each side of the body such that the sides of the body interface with the electrical device as the border interfaces with an outer perimeter of a housing of the electrical device.

4. The battery replacement device of claim 3, wherein the border is dimensioned to create a transition fit between the border and the electrical device.

5. The battery replacement device of claim 1, wherein the battery coupling device comprises an adhesive pad, wherein the adhesive pad comprises:
a first side;
a second side opposite the first side, wherein the second side is to couple the adhesive pad to the body;
an adhesive layer coupled to the first side; and
a release liner removably coupled to the adhesive layer.

6. The battery replacement device of claim 1, wherein the battery coupling device comprises a retention snap to couple the used battery of the electrical device to the first portion of the body.

7. The battery replacement device of claim 1, comprising a plurality of orientation guides extending from the body to define an application orientation of the battery replacement device.

8. A battery replacement system comprising:
a body;
an alignment guide coupled to the body to fit around a portion of an electrical device to guide the battery replacement system in alignment with the electrical device;
an adhesive pad coupled to a first portion of the body; and
a replacement battery removably coupled to a second portion of the body.

9. The battery replacement system of claim 8, wherein the replacement battery protrudes from a surface of the body and is located on the body such that when the battery replacement system is coupled to the electrical device, the replacement battery is seated within a battery compartment of the electrical device.

10. The battery replacement system of claim 8, wherein the adhesive pad comprises:
a first side;
a second side opposite the first side, wherein the second side is to couple the adhesive pad to the body;
an adhesive layer coupled to the first side of the adhesive pad; and
a release liner removably coupled to the adhesive layer.

11. The battery replacement system of claim 8, wherein the replacement battery is removably coupled to the second portion of the body using a replacement battery coupling device.

12. The battery replacement system of claim 8, comprising a housing formed in the body to surround a portion of the replacement battery.

13. The battery replacement system of claim 8, wherein the replacement battery comprises a captive screw to couple the replacement battery to the electrical device.

14. A battery replacement device comprising:
a body;
a battery coupling device formed at a first portion of the body to couple to a used battery of an electrical device;
a recess defined in a second portion of the body to retain a replacement battery; and
a plurality of orientation guides extending from the body to define an application orientation of the battery replacement device.

15. The battery replacement device of claim 14, comprising an alignment guide coupled to the body to create a transition fit around a portion of an electrical device to guide the battery replacement device in alignment with the electrical device.
